(19) United States
(12) Patent Application Publication
(10) Pub. No.: US 2013/0220035 A1
(43) Pub. Date: Aug. 29, 2013

(54) SMOKE DUST SAMPLING GUN WITH A SMOKE DEWATERING DEVICE

(71) Applicants: Yueping Song, Shanxi (CN); Hui Wang, Shanxi (CN); Hanbing Yan, Shanxi (CN); Yindi Bi, Shanxi (CN)

(72) Inventors: Yueping Song, Shanxi (CN); Hui Wang, Shanxi (CN); Hanbing Yan, Shanxi (CN); Yindi Bi, Shanxi (CN)

(73) Assignees: Shanxi Electric Power Research Instittute, Shanxi (CN); Shanxi Electric Power Company, Shanxi (CN)

(21) Appl. No.: 13/882,152

(22) PCT Filed: Aug. 29, 2011
(86) PCT No.: PCT/CN2011/001443

§ 371 Date: Apr. 26, 2013

(30) Foreign Application Priority Data
Nov. 18, 2010 (CN) 201010548836.7

(51) Int. Cl. G01N 1/24

(52) U.S. Cl. CPC G01N 1/24
USPC 73/863.23

(57) ABSTRACT

Disclosed is a smoke dust sampling gun with a smoke dewatering device, with one end of a connecting sleeve (17) thereof being fix connected to the rear part of a gun body (20) and the other end being connected with a smoke dewatering device, wherein the smoke dewatering device comprises a circular tube-shaped dehydrator main body (2) and a circular tube-shaped discharged water storing cabin (3), with a plurality of wave-shaped red copper cooling fins (9) for gas being arranged in parallel inside the circular tube-shaped dehydrator main body (2) along the direction of the circular tube's central axis, and a gas inlet end of the circular tube-shaped dehydrator main body (2) and a gas outlet end of the discharged water storing cabin (3) being fix connected to each other; an end face (12) of a gas outlet end of a gas inlet pipe (5) is, having passed successively through the discharged water storing cabin (3) and a top face (11) of a cone-shaped inlet hopper (13), arranged in the cone-shaped inlet hopper (13); and an inner lining (10) of the discharged water storing cabin (3) is of a tapering shape. The sampling gun is simple in structure, thereby solving the problem of the existing equipment, i.e. that sampling equipment is easily damaged during the smoke dust sampling process, and is suitable for various kinds of smoke dust sampling equipment.

### BACKGROUND

1. Field

The invention relates to a smoke dust sampling gun, and more specifically, to a smoke dust sampling gun with a smoke dewatering device.

2. Description of the Related Art

A smoke dust sampling gun is an important equipment in the test of smoke and dust emission from boilers. In the test of smoke and dust emission from boilers, the smoke dust sampling gun stays at different locations along the boiler flue as required for sampling. The smoke exhausted from the boiler is of high temperature and high humidity. However, the sampling gun does not have filtering water and dewatering functions. After the smoke passing through the sampling gun is drawn out from the smoke collecting system and meets cold air to be cooled, a certain amount of moist which is contained in the smoke may convert into liquid water. Thereby, the smoke collecting pipe may be frozen and blocked by the liquid water, such that the collecting system could not sample the smoke and thus could not function properly. Since the liquid water may enter a sampling device so that the sampling device might be blocked or damaged, the life span of the smoke dust sampling gun might be shortened.

### SUMMARY

The smoke dust sampling gun with a smoke dewatering device proposed by the invention solves the problem as follows associated with the prior sampling gun: since the pipe tends to be blocked by the condensed water due to absence of filtering water and dewatering functions in the prior sampling gun, the sampling equipment may be damaged during smoke dust sampling process.

The invention solves the above-mentioned problem by means of the following technical solutions.

A smoke dust sampling gun with a smoke dewatering device, comprises a smoke dust sampling gun body, a handle which is provided on the smoke dust sampling gun body, and a connecting sleeve, wherein one end of the connecting sleeve is fixedly connected with the tail of the smoke dust sampling gun body, and the other end of the connecting sleeve is connected with a smoke dewatering device, and the smoke dewatering device comprises a dewatering body made of a copper circular pipe, a circular tube-shaped discharged water storing cabin, and an outlet cover; the outlet cover is provided at the outlet of the dewatering body made of the copper circular pipe, and the outlet cover is provided with an outlet pipe at the center thereof, and the copper dewatering body is arranged with a plurality of wave-shaped gas-cooling fins of bronze in parallel with the central axis of the circular pipe, the two sides of the wave-shaped gas-cooling fins of bronze are fixedly connected with the inner sidewalls of the dewatering body of the circular pipe respectively, and the wave-shaped gas-cooling fins of bronze are provided with V-shape notches at the inlet sides thereof, and the V-shape notches at the inlet sides of the plurality of wave-shaped gas-cooling fins of bronze constitute a conical inlet hopper, and the inlet end of the dewatering body made of the copper circular pipe is fixedly connected with the outlet end of the discharged water storing cabin, and the discharged water storing cabin is fixedly connected with an inlet pipe at the inlet thereof, the inlet pipe is in communication with the smoke dust suction open of the smoke dust sampling gun body, and the end surface of the outlet side of the inlet pipe passes through the discharged water storing cabin and the top surface of the conical inlet hopper successively, and is provided in the conical inlet hopper, and the inner lining of the discharged water storing cabin assumes a conical shape, and the inner wall at the smaller open of the conical inner lining and the inner wall at the inlet of the dewatering body are connected with each other smoothly, and the larger open of the conical inner lining is provided on the inner side at the inlet pipe end of the discharged water storing cabin, and a discharge pipe opening is provided on the sidewall of the inlet pipe of the discharged water storing cabin, and the discharge pipe opening is connected with a storage canister via a rubber hose, and the storage canister is fixed to the smoke dust sampling gun body on the side thereof via a fixing collar for a storage canister, and the sidewall at the outlet end of the dewatering body is provided with a backup outlet pipe opening, and the backup outlet pipe opening is provided with a rubber plug which is operative.

The inlet of the dewatering body made of a copper circular pipe is threadably connected to the outlet of the discharged water storing cabin.

The outside wall of the inlet of the discharged water storing cabin is provided with connecting screws, by which the discharged water storing cabin is connected to the connecting sleeve.

The invention is simple in structure, and is easy to be assembled or disassembled. The life span of the smoke dust sampling device is prolonged and the sampling quality is improved. The invention is applicable for various kinds of sampling devices.

### BRIEF DESCRIPTION OF THE DRAWINGS

FIG. 1 is a structural view schematically showing the smoke dewatering device according to the invention;

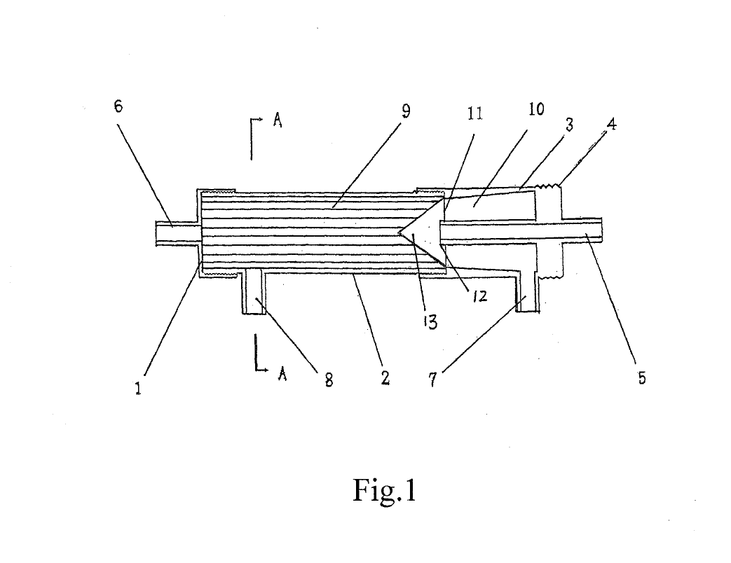

FIG. 2 is a cross sectional view taken along lines A-A in FIG. 1;

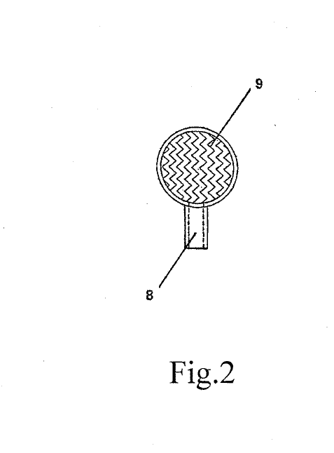

FIG. 3 is a structural view schematically showing the invention.

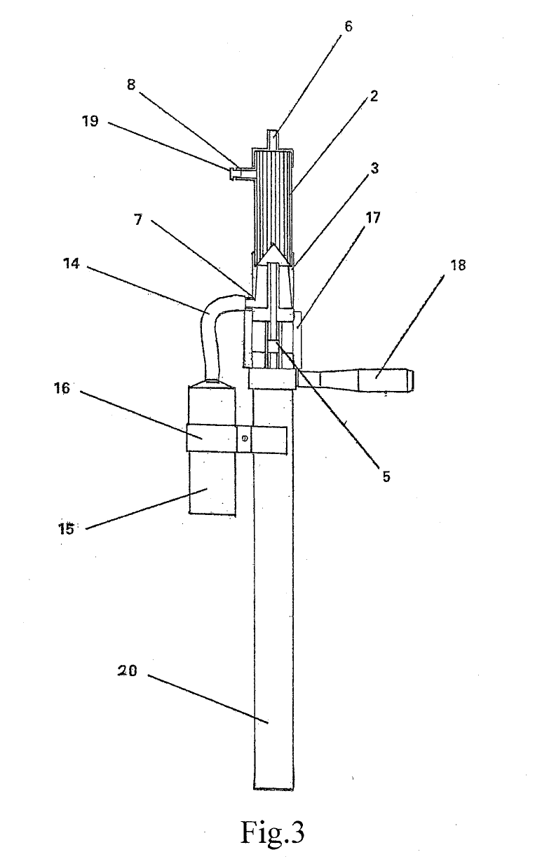

### DETAILED DESCRIPTION

A smoke dust sampling gun with a smoke dewatering device comprises a smoke dust sampling gun body 20, a handle 18 which is provided on the smoke dust sampling gun body 20, and a connecting sleeve 17, wherein one end of the connecting sleeve 17 is fixedly connected with the tail of the smoke dust sampling gun body 20, and the other end of the connecting sleeve 17 is connected with a smoke dewatering device. The smoke dewatering device comprises a dewatering body 2 made of a copper circular pipe, a circular tube-shaped discharged water storing cabin 3, and an outlet cover 1. The outlet cover 1 is provided at the outlet of the copper dewatering body 2. The outlet cover 1 is provided with an outlet pipe 6 at the center thereof. The outlet pipe 6 is connected with the suction hose of the sampling device. The dewatering body 2 made of copper circular pipe is arranged therein with a plurality of wave-shaped gas-cooling fins of bronze 9 which are in parallel with the central axis of the circular pipe. The two sides of the wave-shaped gas-cooling fins of bronze 9 are fixedly connected with an inner sidewall of the dewatering body 2, respectively. The wave-shaped gas-cooling fins of bronze 9 are provided with V-shape notches at the inlet sides thereof so as to direct the condensed water drops, such that the water drops which are condensed on the gas-cooling fins flow along a V-shape rump. The V-shape notches at the inlet sides of the plurality of wave-shaped gas-cooling fins of bronze 9 constitute a conical inlet hopper 13, such that the water drops which form at the inlet sides form a gradient, which contributes to the discharge of the condensed water. The inlet of the dewatering body 2 made of a copper circular pipe is fixedly connected with the outlet of the discharged water storing cabin 3. The discharged water storing cabin 3 is fixedly connected with an inlet pipe 5 at the inlet thereof. The end surface of the inlet side of the inlet pipe 5 is provided on the outside of the discharged water storing cabin 3. The end surface 12 of the outlet side of the inlet pipe 5 passes through the discharged water storing cabin 3 and the top surface 11 of the conical inlet hopper 13 successively, and is provided in the conical inlet hopper 13. An inner lining 10 of the discharged water storing cabin 3 assumes a conical shape. The inner wall at the smaller open of the conical inner lining 10 and the inner wall at the inlet of the dewatering body 2 are connected with each other smoothly. The larger open of the conical inner lining 10 is provided on the inner side of the inlet pipe of the discharged water storing cabin 3. A discharge pipe opening 7 is provided on the sidewall of the inlet pipe end of the discharged water storing cabin 3. The sidewall at the outlet end of the dewatering body 2 of the circular pipe is provided with a backup outlet pipe opening 8. The conical inner lining 10 assumes a shape in which the top size is smaller than its bottom size, so that the condensed water is avoided to flow toward the sampling and suction end and the discharging of the condensed water is facilitated when the dewatering device of the smoke dust sampling gun operates to sample at a horizontal position. The end surface 12 of the outlet side of the inlet pipe 5 passing through the discharged water storing cabin 3 and the top surface 11 of the conical inlet hopper 13 successively and being provided in the conical inlet hopper 13 prevents that the condensed water is flows back into the inlet pipe of the smoke and thus blocks the inlet pipe. The employment of the dewatering body 2 made of a copper circular pipe and the wave-shaped gas-cooling fins 9 of bronze facilitates promoting the cooling and heat dissipation effects of the gas-cooling fins and accelerates condensation of smoke.

The inlet end of the dewatering body 2 made of a copper circular pipe is threadably connected to the outlet end of the discharged water storing cabin 3. The outside wall at the inlet end of the discharged water storing cabin 3 is provided with connecting screws 4 for connecting the sampling device.

The length of the dewatering device of the smoke dust sampling gun which is in use can be determined according to the outdoor temperature. In summer, the dewatering device of the smoke dust sampling gun can be made longer at the dewatering portion such that the moisture contained in the smoke can be adequately condensed. The shape of the wave-shaped gas-cooling fins 9 can be determined depending on the amount of moisture contained in the smoke. The gas-cooling fin may assume a straight-plate shape, a wave-shaped shape, or a wavy shape. It may also be made of bronze fins, in a shape of intersecting parallels or in a radiating shape, so as to enhance dewatering effect.

In the operation of the dewatering device of the smoke dust sampling gun, the backup outlet pipe opening 8 which is provided on the sidewall at the outlet end of the dewatering body 2 should be blocked by a rubber plug 19. The storage canister 15 is connected to the outlet pipe opening 7 which is provided on the sidewall at the inlet pipe end of the discharged water storing cabin 3 by means of a rubber hose 14, and a fixing collar 16 for the storage canister is employed to fix the storage canister 15 to the sampling gun such that the horizontal position of the storage canister is always lower than that of the dewatering device so as to prevent the condensed water from flowing back. In sampling, the inlet pipe 5 of the dewatering device is connected to the smoke pipe at the tail of the sampling gun via a rubber hose, and the smoke dust sampling gun is connected via the connecting sleeve 17 thereof, such that the smoke dewatering device and the smoke dust sampling gun integrate as one piece. The suction hose of the smoke dust sampling device and the outlet pipe 6 are connected with each other, and in this way the smoke dust sampling system as a whole is closed.

What is claimed is:

1. A smoke dust sampling gun with a smoke dewatering device, comprising a smoke dust sampling gun body (20), a handle (18) which is provided on the smoke dust sampling gun body (20), and a connecting sleeve (17), wherein one end of the connecting sleeve (17) is fixedly connected with the tail of the smoke dust sampling gun body (20), and the other end of the connecting sleeve (17)is connected with a smoke dewatering device, characterized in that, the smoke dewatering device comprises a dewatering body (2) made of a copper circular pipe, a circular tube-shaped discharged water storing cabin (3), and an outlet cover (1); the outlet cover (1) is provided at the outlet of the dewatering body (2) made of the copper circular pipe, and the outlet cover (1) is provided with an outlet pipe (6) at the center thereof, and the copper dewatering body (2) is arranged with a plurality of wave-shaped gas-cooling fins of bronze (9) in parallel with the central axis of the circular pipe, the two sides of the wave-shaped gas-cooling fins of bronze (9) are fixedly connected with the inner sidewalls of the dewatering body (2) of the circular pipe respectively, and the wave-shaped gas-cooling fins of bronze (9) are provided with V-shape notches at the inlet sides thereof, and the V-shape notches at the inlet sides of the plurality of wave-shaped gas-cooling fins of bronze (9) constitute a conical inlet hopper (13), and the inlet end of the dewatering body (2) made of the copper circular pipe is fixedly connected with the outlet end of the discharged water storing cabin (3), and the discharged water storing cabin (3) is fixedly connected with an inlet pipe (5) at the inlet thereof, the inlet pipe (5) is in communication with the smoke dust suction open of the smoke dust sampling gun body (20), and the end surface (12) of the outlet side of the inlet pipe (5) passes through the discharged water storing cabin (3) and the top surface (11) of the conical inlet hopper (13) successively, and is provided in the conical inlet hopper (13), and the inner lining (10) of the discharged water storing cabin (3) assumes a conical shape, and the inner wall at the smaller open of the conical inner lining (10) and the inner wall at the inlet of the dewatering body (2) are connected with each other smoothly, and the larger open of the conical inner lining (10) is provided on the inner side at the inlet pipe end of the discharged water storing cabin (3), and a discharge pipe opening (7) is provided on the sidewall of the inlet pipe of the discharged water storing cabin (3), and the discharge pipe opening (7) is connected with a storage canister (15) via a rubber hose (14), and the storage canister (15) is fixed to the smoke dust sampling gun body (20) on the side thereof via a fixing collar (16) for a storage canister, and the sidewall at the outlet end of the dewatering body (2) is provided with a backup outlet pipe opening (8), and the backup outlet pipe opening (8) is provided with a rubber plug (19) which is operative.

2. The smoke dust sampling gun with a smoke dewatering device according to claim 1, characterized in that, the inlet of the dewatering body (2) made of a copper circular pipe is threadably connected to the outlet of the discharged water storing cabin (3).

3. The smoke dust sampling gun with a smoke dewatering device according to claim 1 or claim 2, characterized in that, the outside wall of the inlet of the discharged water storing cabin (3) is provided with connecting screws (4), by which the discharged water storing cabin (3) is connected to the connecting sleeve (17).
